(19) United States
(12) Patent Application Publication
(10) Pub. No.: US 2026/0130386 A1
(43) Pub. Date: May 14, 2026

(54) EMULSIFYING PROCESS AND USE OF LIPID SUBSTANCE

(71) Applicant: GUANGDONG YICHAO BIOLOGICAL CO.,LTD., SHANTOU (CN)

(72) Inventors: RUITENG LIN, SHANTOU (CN); KAIHONG WU, SHANTOU (CN); XUEJUN XIAO, SHANTOU (CN)

(21) Appl. No.: 19/169,485

(22) Filed: Apr. 3, 2025

(30) Foreign Application Priority Data
Nov. 13, 2024 (CN) 202411616984.6

(51) Int. Cl. A23D 7/04; A23G 3/40; B01F 23/41; B01F 23/411; B01F 23/43; B01F 31/00; B01F 31/445; B01F 31/80; B01F 35/32; B01F 35/33; B01F 35/75; B01F 35/90; B01F 35/93; B01F 101/06

(52) U.S. Cl. CPC A23D 7/04; A23G 3/40; B01F 23/4105; B01F 23/4111; B01F 23/43; B01F 31/445; B01F 31/70; B01F 31/83; B01F 35/3204; B01F 35/323; B01F 35/332; B01F 35/7547; B01F 35/93; B01F 2035/99; B01F 2101/06

(57) ABSTRACT

An emulsification process and use of lipid substances are provided. The process includes: adding an emulsification raw material into an emulsification cylinder through a feeding pipe, and setting the temperature and pressure; turning on an ultrasonic generator; turning on a driving motor, such that the driving motor drives a stirring mechanism to rotate to stir the emulsion to drive the emulsification raw material to flow circumferentially; the stirring mechanism driving shearing mechanisms to intermittently reversely move to shear, disperse and impact the emulsion; and opening a valve on a liquid outlet pipe to discharge the emulsion, wherein an emulsifying device is further included and includes an emulsification cylinder which is installed on a base, and a liquid outlet pipe is provided at the bottom of the emulsification cylinder; and the stirring mechanism drives, when moving, the shearing mechanisms to intermittently reversely move to shear, disperse and impact the emulsion.

### CROSS REFERENCE TO RELATED APPLICATIONS

The present disclosure claims the priority to the Chinese patent application with the filing NO. 202411616984.6, entitled “EMULSIFYING PROCESS AND USE OF LIPID SUBSTANCE” and filed on Nov. 13, 2024 with the Chinese Patent Office, the contents of which are incorporated herein by reference in their entirety.

### TECHNICAL FIELD

The present disclosure relates to the technical field of emulsification of lipid substances, and in particular to an emulsifying process and use for a lipid substance.

### BACKGROUND ART

In the food and pharmaceutical industries, water-insoluble or poorly water-soluble lipid raw materials usually need to be prepared into water-soluble or hydrophilic products to achieve intended use and improve bioavailability. The current mainstream technology uses water as a carrier and adds various emulsifiers. The emulsifiers mainly function to increase the surface tension of the liposome, so that it can be better mixed with water to form microparticle micelles. Commonly used emulsifiers include various fatty acid glycerides, gum arabic, alginic acid, sodium caseinate, gelatin, phospholipids, etc. In all these traditional lipid emulsification processes, the lipid components are required to be mixed with emulsifiers, water, etc., and then subjected to processes such as homogenization, sterilization or addition of antibacterial agents, filling or freeze-drying, to obtain final products. For the products under this process, a large amount of thickeners, antibacterial agents, etc. often need to be added to maintain the stability of the aqueous solution product, or dried to increase the shelf life and the stability of the product.

The emulsion needs to be stirred in the lipid emulsification process. The existing stirring mechanism generally uses a conventional mixer for stirring and emulsification. However, the conventional mixer has just one stirring shaft and some stirring blades inside, which lacks the shearing, dispersion and impact effects on the material. Due to the poor stirring effect, it cannot make the material more finely dispersed, resulting in a decrease in the emulsification speed and emulsification effect of lipid substances.

### SUMMARY

In view of the deficiencies in the prior art, the present disclosure provides an emulsifying process for a lipid substance and a use thereof, which drives the shearing mechanism(s) to intermittently reversely move when the stirring mechanism moves, so as to shear, disperse and impact the emulsion, aiming to solve the problems in the background art.

In order to achieve the above technical purpose, the specific technical solution of the present disclosure is as follows. The emulsifying process for a lipid substance proposed by the present disclosure includes the following steps:
S1, adding an emulsification raw material into an emulsification cylinder through a feeding pipe and setting a temperature and a pressure;
S2, turning on an ultrasonic generator;
S3, turning on a driving motor, such that the driving motor drives a stirring mechanism to rotate to stir an emulsion to drive the emulsification raw material to flow circumferentially;
S4, the stirring mechanism driving shearing mechanisms to intermittently move reversely to shear, disperse and impact the emulsion; and
S5, opening a valve on a liquid outlet pipe to discharge the emulsion;
an emulsifying device is further included, where the emulsifying device includes the emulsification cylinder, the emulsification cylinder is installed on a base, and the liquid outlet pipe is provided at a bottom of the emulsification cylinder; a fixing frame is fixedly connected to the base, a lifting mechanism is fixedly connected to the fixing frame, a cylinder cover in sealed connection with the emulsification cylinder is fixedly connected to the lifting mechanism, and the feeding pipe is connected to the cylinder cover; a stirring mechanism is connected below the cylinder cover, the stirring mechanism is configured to stir and make the emulsion flow unidirectionally and circumferentially, and an annular frame is fixedly connected below the cylinder cover, a pair of shearing mechanisms capable of rotating back and forth are symmetrically connected to the annular frame, and are configured to shear, disperse and impact the emulsion, and the stirring mechanism drives, when moving, the two shearing mechanisms to move intermittently, and when shearing, a movement direction of each of the shearing mechanisms is opposite to a flow direction of the emulsion.

As a preferred technical solution of the present disclosure, each of the shearing mechanisms includes a slider, the annular frame is provided with a sliding hole slidably connected to the slider, and the slider is connected to a liftable baffle frame, a first elastic member is fixedly connected between the baffle frame and the slider; the slider is rotatably connected with a rotating roller, the rotating roller is connected to liftable shearing frame(s), and the shearing frame is fixedly connected to a plurality of shearing rods.

As a preferred technical solution of the present disclosure, the stirring mechanism includes a rotating disk, a plurality of stirring frames are fixedly connected below the rotating disk, and a pair of brackets are fixedly connected to the rotating disk, each of the brackets is rotatably connected to a first gear, and a limit frame configured to cooperate with the baffle frame is coaxially fixedly connected to the first gear, and a plurality of limit rods are evenly arranged on the limit frame in a circumferential direction thereof; and a first arc-shaped rack configured to cooperate with the first gear is fixedly connected to the slider.

As a preferred technical solution of the present disclosure, a tension spring is fixedly connected between the slider and the annular frame, and a roller is connected to the baffle frame. A limiting guide rail configured to cooperate with the roller is fixedly connected to the annular frame, and the limiting guide rail is arranged at one end of the sliding hole, where when the roller rolls on the limiting guide rail, the baffle frame is driven to descend, so that the limit frame is separated from the baffle frame.

As a preferred technical solution of the present disclosure, a second gear is coaxially fixedly connected to the rotating roller, and a second arc-shaped rack engaged with the second gear is fixedly connected to the annular frame.

As a preferred technical solution of the present disclosure, the rotating roller is slidably connected to a lifting seat, the shearing frame is fixedly connected to the lifting seat, and the rotating roller is provided with a vertical groove slidably connected to the lifting seat, the rotating roller is fixedly connected to a baffle seat, and second elastic member(s) is fixedly connected between the baffle seat and the lifting seat.

As a preferred technical solution of the present disclosure, the lifting seat is fixedly connected to an annular rail, the slider is fixedly connected to support rod(s), the support rod is connected to a pressure wheel configured to cooperate with the annular rail, and the annular rail is provided with recessed groove(s), where when the pressure wheel rolls on the annular rail, the shearing frame is intermittently driven to reciprocate up and down.

As a preferred technical solution of the present disclosure, the ultrasonic generator is installed on the cylinder cover, one end of the ultrasonic generator extends into the emulsification cylinder; a heater is installed on the cylinder cover, the heater is provided with a heating rod, and the heating rod extends into the emulsification cylinder; and an air pipe is installed on the cylinder cover, and a pressure gauge is connected to the air pipe.

As a preferred technical solution of the present disclosure, a driving motor is installed on the cylinder cover, a driving gear is fixedly connected to the driving motor, and a driven gear engaged with the driving gear is coaxially fixedly connected to the rotating disk.

The lipid substance prepared by the present disclosure is used in a DHA algae oil liquid nutrition packages and candies.

The beneficial effects of the present disclosure are as follows.

1. In the present disclosure, when the stirring mechanism moves, the material is driven to flow in the emulsification cylinder, and the stirring mechanism intermittently drives the shearing mechanism to slide from one end of the sliding hole to the other end, and then the stirring mechanism is separated from the shearing mechanism, and the shearing mechanism moves back quickly under the tension of the tension spring, with the movement direction being opposite to the flow direction of the material, so that the shearing mechanism can shear, disperse and impact the material at a higher speed, thereby improving the emulsification and homogenization effects of the material.

2. In the present disclosure, when the shearing mechanism moves back, the rotating roller keeps rotating, and the rotating roller drives, during the rotation, the shearing frame to move up and down, thereby achieving better dispersion and shearing effects on the material and improving the bioavailability.

### BRIEF DESCRIPTION OF DRAWINGS

FIG. 1 is a flow chart of an emulsifying process for a lipid substance provided in the present disclosure.

FIG. 2 is a structural schematic view of an emulsifying device provided in the present disclosure.

FIG. 3 is a schematic view showing the cylinder cover, stirring mechanism, and shearing mechanisms provided in the present disclosure.

FIG. 4 is a schematic view of FIG. 3 from another angle.

FIG. 5 is a schematic front view of FIG. 3.

FIG. 6 is a schematic view showing the annular frame and the shearing mechanisms according to the present disclosure.

FIG. 7 is a partial structural schematic view of FIG. 6.

FIG. 8 is a structural schematic view of the rotating roller provided in the present disclosure.

FIG. 9 is a structural schematic view of the stirring mechanism provided in the present disclosure.

In the drawings: 1, base; 2, emulsification cylinder; 3, cylinder cover; 4, fixing frame; 5, lifting mechanism; 6, stirring mechanism; 61, rotating disk; 62, bracket; 63, first gear; 64, limit frame; 65, limit rod; 66, stirring frame; 7, shearing mechanism; 71, slider; 72, rotating roller; 73, shearing frame; 74, shearing rod; 75, vertical groove; 76, baffle seat; 77, second elastic member; 78, lifting seat; 79, annular rail; 710, recessed groove; 711, baffle frame; 712, roller; 713, first elastic member; 714, second gear; 715, first arc-shaped rack; 716, pressure wheel; 717, support rod; 8, annular frame; 81, sliding hole; 82, tension spring; 83, second arc-shaped rack; 84, limiting guide rail; 9, ultrasonic generator; 10, feeding pipe; 11, heater; 12, heating rod; 13, driving motor; 14, driving gear; 15, driven gear; 16, air pipe; 17, pressure gauge; 18, liquid outlet pipe.

### DETAILED DESCRIPTION OF EMBODIMENTS

The technical solutions in the embodiments of the present disclosure will be described clearly and completely below in conjunction with the drawings in the embodiments of the present disclosure. Obviously, the described embodiments are only some, not all of the embodiments of the present disclosure.

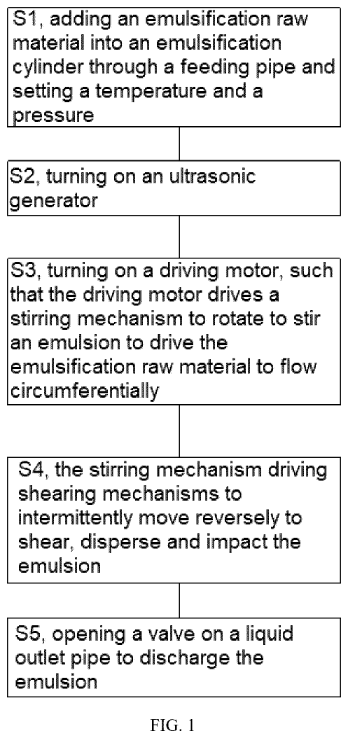

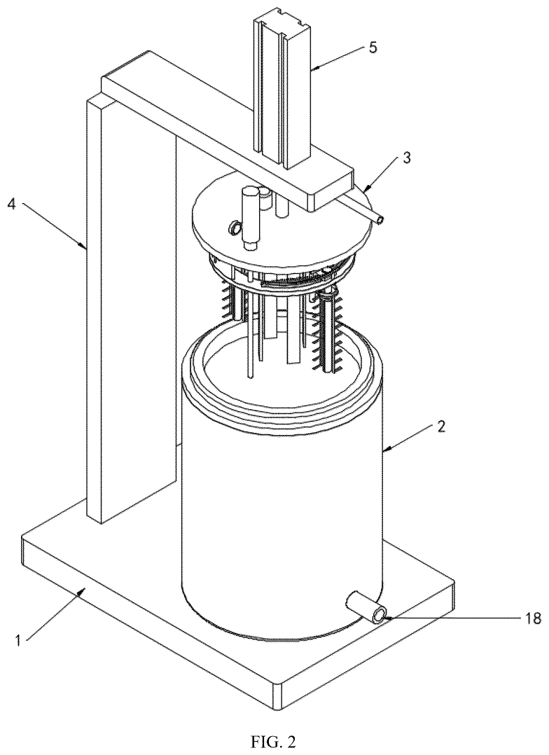

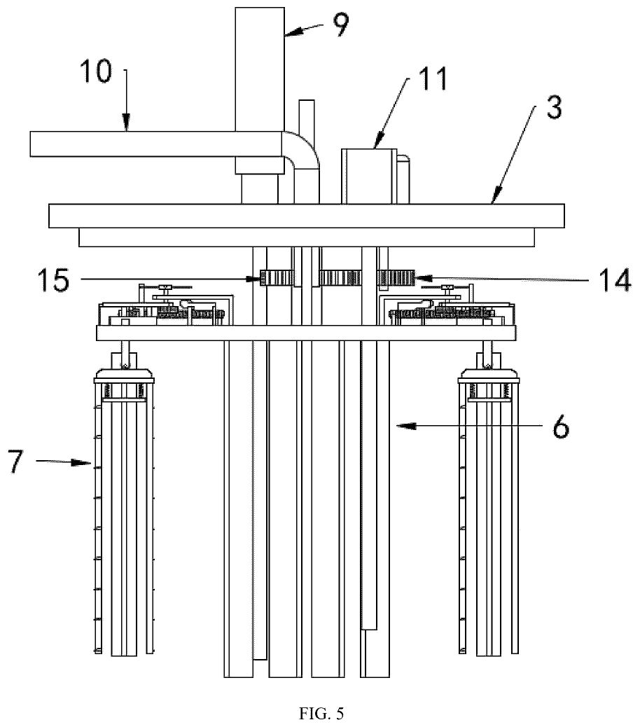

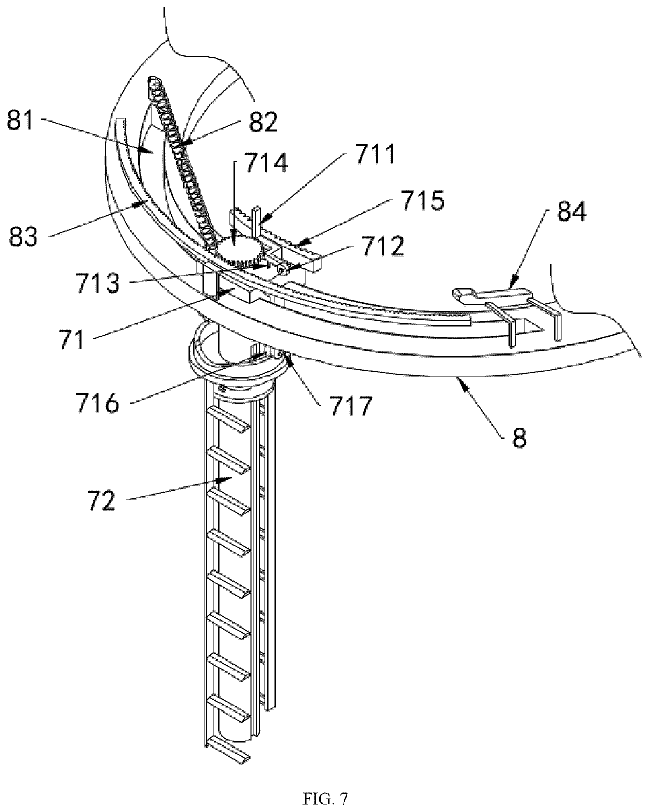

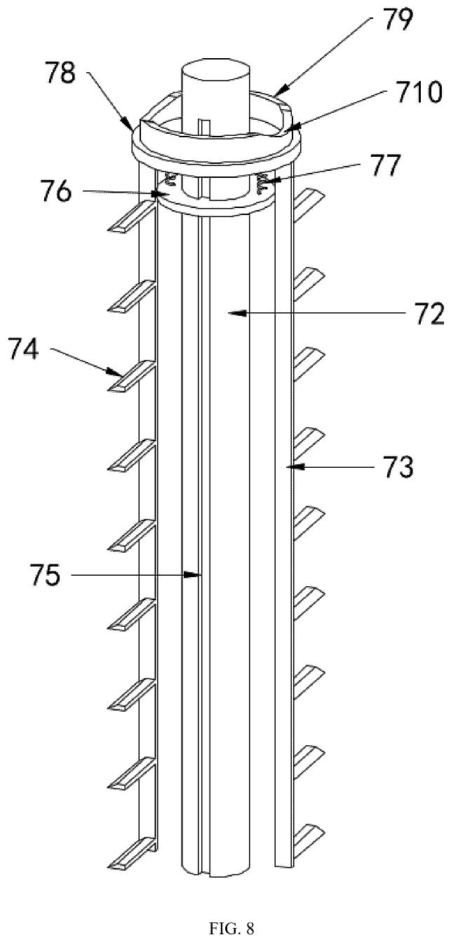

Embodiment: This embodiment discloses an emulsifying process for a lipid substance, as shown in FIGS. 1 to 9, including following steps:
S1, adding an emulsification raw material into an emulsification cylinder 2 through a feeding pipe 10 and setting a temperature and a pressure;
S2, turning on an ultrasonic generator 9;
S3, turning on a driving motor 13, such that the driving motor 13 drives a stirring mechanism 6 to rotate to stir the emulsion to drive the emulsification raw material to flow circumferentially;
S4, the stirring mechanism 6 driving shearing mechanisms 7 to intermittently move reversely to shear, disperse and impact the emulsion; and
S5, opening a valve on the liquid outlet pipe 18 to discharge the emulsion;
an emulsifying device is further included, where the emulsifying device includes the emulsification cylinder 2, the emulsification cylinder 2 is installed on a base 1, the liquid outlet pipe 18 is provided at the bottom of the emulsification cylinder 2, and a valve is provided on the liquid outlet pipe 18; a fixing frame 4 is fixedly connected onto the base 1, a lifting mechanism 5 is fixedly connected to the fixing frame 4, and the lifting mechanism 5 may be a cylinder, a cylinder cover 3 in sealed connection with the emulsification cylinder 2 is fixedly connected to the lifting mechanism 5, and the feeding pipe 10 is connected to the cylinder cover 3; and the material is added to the inside of the emulsification cylinder 2 through the feeding pipe 10.

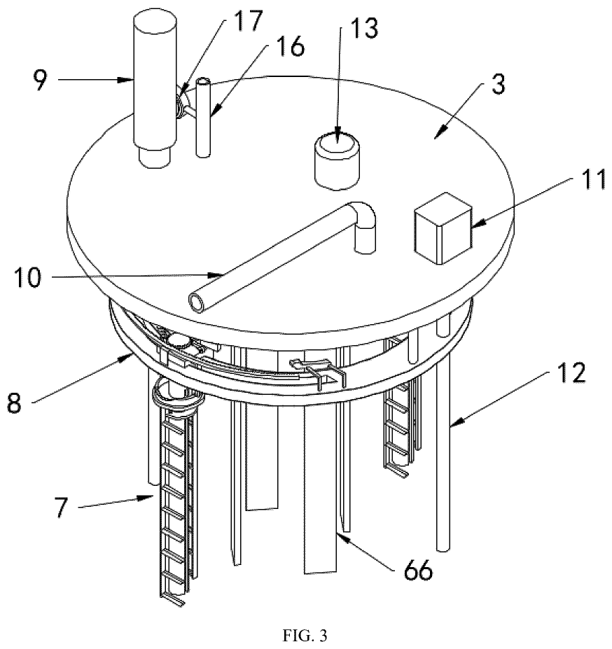

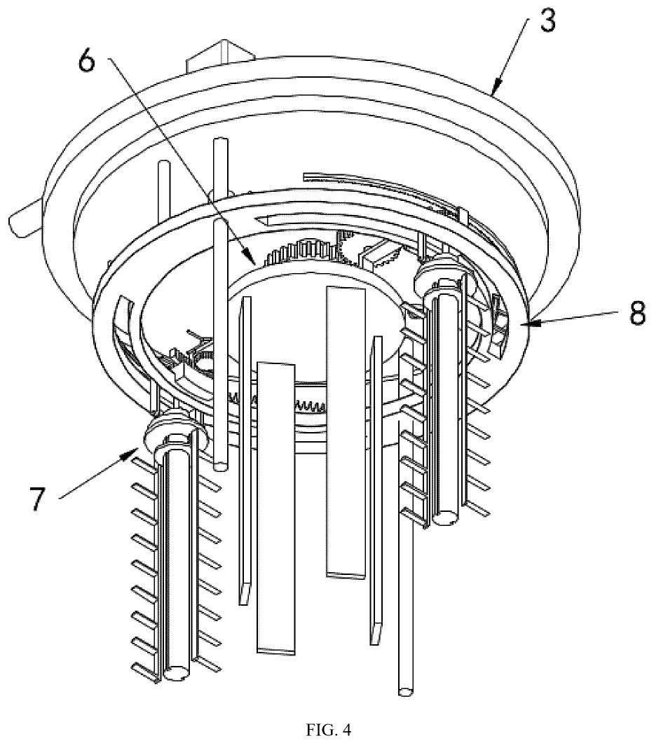

In the above, as shown in FIGS. 3-4, the stirring mechanism 6 is connected below the cylinder cover 3. The stirring mechanism 6 may mix the material as quickly as possible and simultaneously make the material flow circumferentially inside the emulsification cylinder 2. An annular frame 8 is fixedly connected below the cylinder cover 3. The annular frame 8 does not contact the material. A pair of shearing mechanisms 7 capable of rotating back and forth are symmetrically connected to the annular frame 8 to shear, disperse and impact the emulsion to homogenized the emulsion. When moving, the stirring mechanism 6 may drive the two shearing mechanisms 7 to move intermittently, and the movement direction of the shearing mechanism 7 during shearing is opposite to the flow direction of the emulsion, thereby increasing the impact speed of the shearing mechanism 7 on the material and improving the shearing and dispersion effects on the material.

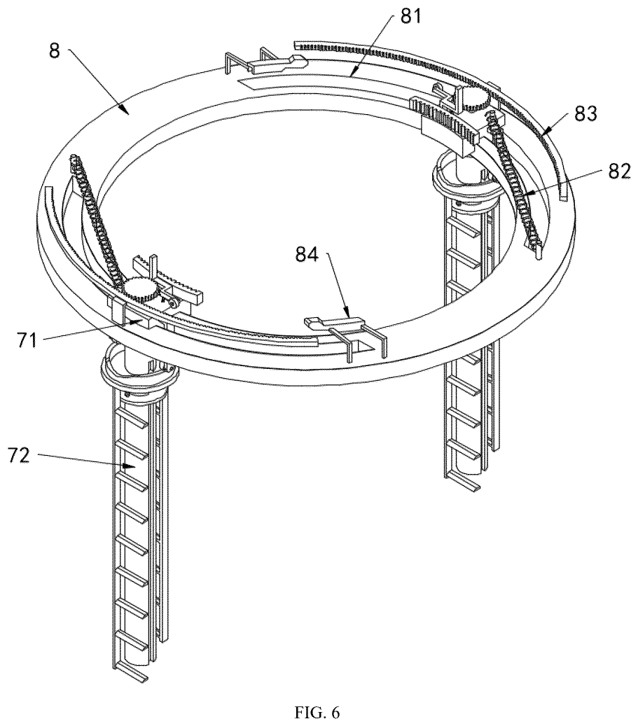

As shown in FIGS. 6-8, the shearing mechanism 7 includes a slider 71. The annular frame 8 is provided with a sliding hole 81 which is slidably connected to the slider 71. A liftable baffle frame 711 is connected to the slider 71. The baffle frame 711 is L-shaped. The baffle frame 711 is slidably connected to the slider 71 up and down. A first elastic member 713 is fixedly connected between the baffle frame 711 and the slider 71. The first elastic member 713 applies an upward elastic force to the baffle frame 711; a rotating roller 72 is rotatably connected below the slider 71, and liftable shearing frames 73 are connected to the rotating roller 72. A pair of shearing frames 73 are provided. Each shearing frame 73 is fixedly connected with a plurality of shearing rods 74. A tension spring 82 is fixedly connected between the slider 71 and the annular frame 8. A roller 712 is connected to the baffle frame 711. A limiting guide rail 84 configured for cooperating with the roller 712 is fixedly connected to the annular frame 8. The limiting guide rail 84 is provided at one end of the sliding hole 81, and the starting end of the limiting guide rail 84 is arranged as an inclined upward structure, facilitating the roller 712 rolling onto the limiting guide rail 84. When the roller 712 rolls onto the limiting guide rail 84, the baffle frame 711 is driven to descend; and when the slider 71 moves towards the limiting guide rail 84, the tension spring 82 is stretched.

A second gear 714 is coaxially fixedly connected to the rotating roller 72. A second arc-shaped rack 83 engaged with the second gear 714 is fixedly connected to the annular frame 8. When the slider 71 slides in the sliding hole 81, the second gear 714 rolls along the second arc-shaped rack 83; a lifting seat 78 is slidably connected to the rotating roller 72, two shearing frames 73 are fixedly connected to the lifting seat 78, and the rotating roller 72 is provided with a vertical groove 75 slidably connected to the lifting seat 78. A baffle seat 76 is fixedly connected to the rotating roller 72. The baffle seat 76 is arranged below the lifting seat 78. Second elastic members 77 are fixedly connected between the baffle seat 76 and the lifting seat 78, and the second elastic members 77 each apply an upward elastic force to the lifting seat 78. An annular rail 79 is fixedly connected to the lifting seat 78. The slider 71 is fixedly connected to support rods 717. A pair of support rods 717 are provided and symmetrically connected to the slider 71. the support rod 717 is connected with a pressure wheel 716 configured for cooperating with the annular rail 79. The annular rail 79 is provided with recessed grooves 710, and a pair of recessed grooves 710 are provided. When the slider 71 slides in the sliding hole 81, the second gear 714 rotates on the second arc-shaped rack 83, and the second gear 714 drives, when rotating, the rotating roller 72 to rotate, and the rotating roller 72 drives the annular rail 79 to rotate, so that when the pressing wheel 716 rolls on the annular rail 79, the lifting seat 78 rises when the pressing wheel 716 rolls to the position of the recessed groove 710, and the lifting seat 78 descends when the pressing wheel 716 rolls out of the recessed groove 710, thereby driving the shearing frame 73 to reciprocate up and down, so that when the slider 71 slides in the sliding hole 81, the rotating roller 72 drives the shearing frame 73 to rotate circumferentially, and simultaneously drives the shearing frame 73 to reciprocate up and down, enabling better shearing and dispersion effects on the material.

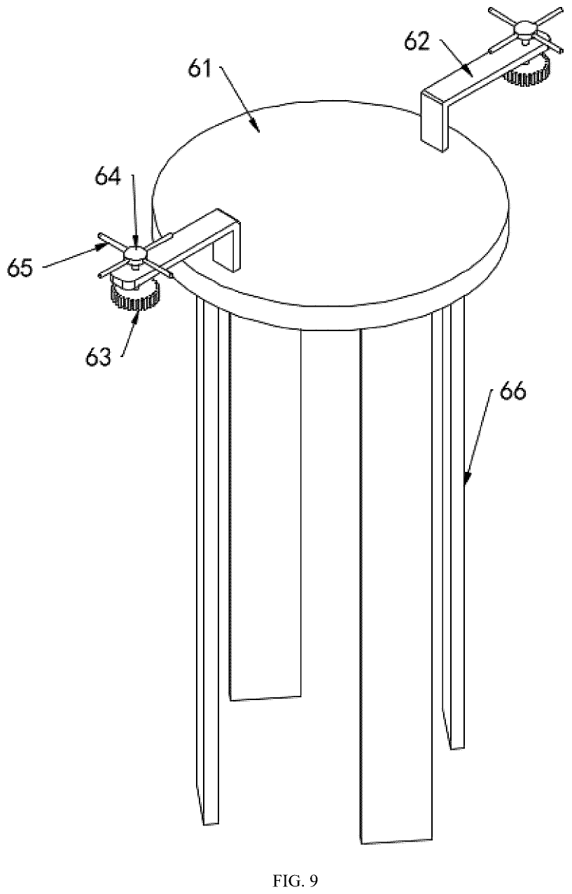

As shown in FIG. 9, the stirring mechanism 6 includes a rotating disk 61. A plurality of stirring frames 66 are fixedly connected below the rotating disk 61, and a pair of brackets 62 are fixedly connected to the rotating disk 61. The bracket 62 is rotatably connected to a first gear 63. The first gear 63 is coaxially fixedly connected to a limit frame 64 configured for cooperating with the baffle frame 711. A plurality of limit rods 65 are evenly arranged on the limit frame 64 in a circumferential direction thereof. A first arc-shaped rack 715 configured for cooperating with the first gear 63 is fixedly connected to the slider 71. When the rotating disk 61 rotates, the bracket 62 is driven to rotate; when the first gear 63 is engaged with the first arc-shaped rack 715, the first gear 63 rotates along with the rotation of the rotating disk 61, until the limit rod 65 contact the baffle frame 711. At this time, due to the blocking by the baffle frame 711, the limit frame 64 and the first gear 63 cannot rotate continuously, so that when the rotating disk 61 continues to rotate, the first gear 63 may drive the slider 71 to slide in the sliding hole 81, the tension spring 82 is stretched, and when the slider 71 slides to the other end of the sliding hole 81, the roller 712 rolls onto the limiting guide rail 84 to drive the baffle frame 711 to descend. The baffle frame 711 no longer blocks the limit rod 65, and the first gear 63 may continue to rotate, at this time, the slider 71 quickly moves back under the tension of the tension spring 82, to drive the shearing frame 73 to move in the direction opposite to the flow direction of the material, thereby causing the shearing frame 73 to impact the material at a higher speed, achieving better shearing and dispersion effects.

Preferably, an ultrasonic generator 9 is installed on the cylinder cover 3. One end of the ultrasonic generator 9 extends into the emulsification cylinder 2 and is used to vibrate the material to disperse and homogenize the material; and a heater 11 is installed on the cylinder cover 3. The heater 11 is provided with a heating rod 12. The heating rod 12 extends into the emulsification cylinder 2, and the heating rod 12 is used to heat the material. The air pipe 16 is installed on the cylinder cover 3, and a pressure gauge 17 is connected to the air pipe 16.

Preferably, a driving motor 13 is installed on the cylinder cover 3, a driving gear 14 is fixedly connected to the driving motor 13, a driven gear 15 engaged with the driving gear 14 is coaxially fixedly connected to the rotating disk 61, the driving motor 13 drives the driving gear 14 to rotate, and the driving gear 14 drives the driven gear 15 to rotate, and then drives the rotating disk 61 to rotate.

The working principle of the shearing mechanism 7: after the material and the emulsifier are added into the emulsification cylinder 2, the driving motor 13 drives the stirring mechanism 6 to rotate. The stirring mechanism 6 stirs the material and drives the material to flow unidirectionally and circumferentially. When the rotating disk 61 rotates, the bracket 62 is driven to rotate. When the first gear 63 is engaged with the first arc-shaped rack 715, the first gear 63 rotates along with the rotation of the rotating disk 61, until the limit rod 65 contacts the baffle frame 711. At this time, due to the blocking by the baffle frame 711, the limit frame 64 and the first gear 63 cannot continuously rotate. When the rotating disk 61 continues to rotate, the first gear 63 may drive the slider 71 to slide in the sliding hole 81, and the tension spring 82 may be stretched. When the slider 71 slides to the other end of the sliding hole 81, the roller 712 rolls onto the limiting guide rail 84, and the baffle frame 711 is driven to descend. The baffle frame 711 no longer blocks the limit rod 65, and the first gear 63 may continue to rotate. At this time, the slider 71 moves back quickly under the tension of the tension spring 82, driving the shearing frame 73 to move in the direction opposite to the flow direction of the material, so that the shearing frame 73 impacts the material at a higher speed, and when the slider 71 slides in the sliding hole 81, the second gear 714 rotates on the second arc-shaped rack 83, and the second gear 714 drives, when rotating, the rotating roller 72 to rotate, and the rotating roller 72 drives the annular rail 79 to rotate, so that when the pressure wheel 716 rolls on the annular rail 79, the shearing frame 73 is then driven to reciprocate up and down, enabling that when the slider 71 slides in the sliding hole 81, the rotating roller 72 drives the shearing frame 73 to rotate circumferentially and simultaneously drives the shearing frame 73 to reciprocate up and down, achieving better shearing and dispersion effects on the material to homogenize the emulsion and improve the bioavailability. The lipid substances prepared by the device of this embodiment are better emulsified, and thus have improved absorption rate. In this solution, in order to improve the emulsification effect of the mixed solution in the preparation process of lipid substances and improve its absorption rate, DHA algae oil is added to the raw materials. The list of ingredients is as follows.

Raw Material

DHA algae oil
Sugar solution
Compound thickener
Flavoring
Edible essence

It should also be noted that the device designed in this solution may also be used in the preparation of substances such as “lutein ester, AA oil, conjugated linoleic acid, astaxanthin, zeaxanthin, carotene, fish oil, krill oil, and Haematococcus pluvialis”.

Further, the lipid substances prepared in this embodiment are used in DHA algae oil liquid nutrition packages and candies.

Finally, it should be noted that in the description of the present disclosure, orientation or position relationships indicated by the terms “vertical”, “upper”, “lower”, “horizontal”, etc. are based on the orientation or position relationships shown in the drawings, which is only for facilitating describing the present disclosure and simplifying the description, rather than indicating or implying that the device or element referred to must have a specific orientation, be constructed and operated in a specific orientation, and therefore cannot be understood as a limitation on the present disclosure.

The above are only preferred embodiments of the present disclosure and are not intended to limit the present disclosure. Although the present disclosure has been described in detail with reference to the aforementioned embodiments, those skilled in the art can still modify the technical solutions described in the aforementioned embodiments or replace some of the technical features therein with equivalents. Any modification, equivalent replacement, improvement, etc. made within the spirit and principle of the present disclosure shall be included in the protection scope of the present disclosure.

1. An emulsifying process for a lipid substance, comprising following steps:
S1, adding an emulsification raw material into an emulsification cylinder through a feeding pipe, and setting a temperature and a pressure;
S2, turning on an ultrasonic generator;
S3, turning on a driving motor, such that the driving motor drives a stirring mechanism to rotate to stir an emulsion to drive the emulsification raw material to flow circumferentially;
S4, the stirring mechanism driving shearing mechanisms to intermittently move reversely to shear, disperse and impact the emulsion; and
S5, opening a valve on a liquid outlet pipe to discharge the emulsion,
wherein an emulsifying device is further included, wherein the emulsifying device comprises an emulsification cylinder, the emulsification cylinder is mounted on a base, and a liquid outlet pipe is provided at a bottom of the emulsification cylinder;
a fixing frame is fixedly connected onto the base, a lifting mechanism is fixedly connected to the fixing frame, a cylinder cover in sealed connection with the emulsification cylinder is fixedly connected to the lifting mechanism, and the feeding pipe is connected to the cylinder cover;
the stirring mechanism is connected below the cylinder cover, the stirring mechanism is configured to stir and make the emulsion flow unidirectionally and circumferentially, an annular frame is fixedly connected below the cylinder cover, and a pair of shearing mechanisms capable of rotating back and forth are symmetrically connected to the annular frame, and are configured to shear, disperse and impact the emulsion; and
the stirring mechanism is configured to drive, during moving, the two shearing mechanisms to move intermittently, wherein a movement direction of each of the shearing mechanisms during shearing is opposite to a flow direction of the emulsion.

2. The emulsifying process for a lipid substance according to claim 1, wherein the shearing mechanism comprises a slider, the annular frame is provided with a sliding hole slidably connected to the slider, and a liftable baffle frame is connected to the slider, and a first elastic member is fixedly connected between the baffle frame and the slider; a rotating roller is rotatably connected to the slider, at least one liftable shearing frame is connected to the rotating roller, and the at least one shearing frame is fixedly connected with a plurality of shearing rods.

3. The emulsifying process for a lipid substance according to claim 2, wherein the stirring mechanism comprises a rotating disk, a plurality of stirring frames are fixedly connected below the rotating disk, a pair of brackets are fixedly connected to the rotating disk, each of the brackets is rotatably connected to a first gear, and the first gear is coaxially fixedly connected with a limit frame configured for cooperating with the baffle frame, and a plurality of limit rods are evenly arranged on the limit frame in a circumferential direction thereof; and a first arc-shaped rack configured for cooperating with the first gear is fixedly connected to the slider.

4. The emulsifying process for a lipid substance according to claim 3, wherein a tension spring is fixedly connected between the slider and the annular frame, a roller is connected to the baffle frame, a limiting guide rail configured for cooperating with the roller is fixedly connected to the annular frame, and the limiting guide rail is provided at one end of the sliding hole, wherein when the roller rolls onto the limiting guide rail, the baffle frame is driven to descend, so that the limit frame is separated from the baffle frame.

5. The emulsifying process for a lipid substance according to claim 4, wherein a second gear is coaxially fixedly connected to the rotating roller, and a second arc-shaped rack engaged with the second gear is fixedly connected to the annular frame.

6. The emulsifying process for a lipid substance according to claim 5, wherein a lifting seat is slidably connected to the rotating roller, the at least one shearing frame is fixedly connected to the lifting seat, and the rotating roller is provided with a vertical groove slidably connected to the lifting seat, a baffle seat is fixedly connected to the rotating roller, and at least one second elastic member is fixedly connected between the baffle seat and the lifting seat.

7. The emulsifying process for a lipid substance according to claim 6, wherein an annular rail is fixedly connected to the lifting seat, the slider is fixedly connected to at least one support rod, the at least one support rod is connected with a pressure wheel configured for cooperating with the annular rail, and the annular rail is provided with at least one recessed groove, and the pressure wheel is configured for intermittently driving, when rolling on the annular rail, the at least one shearing frame to reciprocate up and down.

8. The emulsifying process for a lipid substance according to claim 7, wherein an ultrasonic generator is installed on the cylinder cover, and one end of the ultrasonic generator extends into the emulsification cylinder; a heater is installed on the cylinder cover, the heater is provided with a heating rod, and the heating rod extends into the emulsification cylinder; and an air pipe is installed on the cylinder cover, and a pressure gauge is connected to the air pipe.

9. The emulsifying process for a lipid substance according to claim 8, wherein a driving motor is installed on the cylinder cover, a driving gear is fixedly connected to the driving motor, and a driven gear engaged with the driving gear is coaxially fixedly connected to the rotating disk.

10. A lipid substance prepared by the emulsifying process according to claim 1, applicable to DHA algae oil liquid nutrition packages and candies.
